(19) United States
(12) Patent Application Publication
(10) Pub. No.: US 2019/0341785 A1
(43) Pub. Date: Nov. 7, 2019

(54) BATTERYBALANCE SYSTEM AND OPERATION METHOD THEREOF

(71) Applicant: Guan-Jie Luo, Taipei (TW)

(72) Inventor: Shao-Wei Chiu, Taipei (TW)

(73) Assignee: Guan-Jie Luo, Taipei (TW)

(21) Appl. No.: 16/402,152

(22) Filed: May 2, 2019

(30) Foreign Application Priority Data
May 4, 2018 (TW) 107115327

(51) Int. Cl. H02J 7/00; H01M 10/44

(52) U.S. Cl. CPC H02J 7/0014; H01M 10/441; H02J 7/0021

(57) ABSTRACT

The present invention provides a battery balance system which includes a plurality of battery modules and a control module. Each of the battery modules includes a battery, a passive power adjustment unit and an active power adjustment unit. The passive power adjustment units and the active power adjustment units are coupled to the batteries. The control module is coupled to the battery modules, and is configured to monitor charging powers of the batteries. In a charging period, when a charging power of a first battery of a first battery module of the battery modules is higher than a charging power of a second battery of a second battery module of the battery modules, the control module enables the passive power adjustment unit of the first battery module. The control module determines whether or not to enable the active power adjustment unit of the first battery module according to a charging power difference between the first battery and the second battery.

### CROSS REFERENCE

The present invention claims priority to TW 107115327, filed on May 4, 2018.

### BACKGROUND OF THE INVENTION

### Field of Invention

The present invention relates to a battery balance system and method thereof.

### Description of Related Art

The progress of science and technology brings environmental pollution, while improving living level. With a rise of environmental protection activities, the current research and development of products must consider the environmental protection. Using an electric engine instead of an internal combustion engine as a car driving force, is a good example.

In general, a large number of batteries are inserted in the electric engine. These batteries may be connected in series, in parallel, or partially in series and partially in parallel, to form an electrical power source. However, due to the accuracy limitation for production, there are some usual differences between the batteries, such as different electrical storage capacity, different charging/discharging speed, etc.

Taking the electric engine with lithium batteries as an example, if the charging and/or discharging speeds between the batteries are different, some batteries may be overcharged or over-discharged, such that the batteries may have serious problems such as overheating, combustion, or even explosion. Therefore, how to balance the charging powers between the batteries is always one research topic in the field.

### SUMMARY OF THE INVENTION

In order to balance charging powers between the batteries, the present invention provides a battery balance system and method thereof.

In one embodiment, the present invention discloses a battery balance system which includes a plurality of battery modules and a control module. Each of the battery modules includes a battery, a passive power adjustment unit and an active power adjustment unit. Each of the passive power adjustment unit and each of the active power adjustment unit are coupled to the batteries. The control module is coupled to the battery modules, and is configured to monitor charging powers of the batteries. In a charging period, when a charging power of a first battery of a first battery module of the battery modules is higher than a charging power of a second battery of a second battery module of the battery modules, the control module enables the passive power adjustment unit of the first battery module, to reduce the charging power of the first battery by the passive power adjustment unit of the first battery module. The control module determines whether or not to enable the active power adjustment unit of the first battery module according to a charging power difference between the first battery and the second battery, for transferring the charging power of the first battery to the second battery by the active power adjustment unit of the first battery module.

In one embodiment, the present invention provides an operation method of battery balance system, which includes: monitoring a plurality of charging powers of a plurality of battery modules; determining whether the charging powers of the batteries are equivalent to each other; when the charging powers of the batteries in the battery modules are not equivalent to each other and the charging power of a first battery of a first battery module of the battery modules is higher than the charging power of a second battery of a second battery module of the battery modules, a passive power adjustment unit in the first battery module is enabled to reduce the charging power of the first battery by the passive power adjustment unit; and determining whether or not to enable an active power adjustment unit of the first battery module according to a charging power difference between the first battery and the second battery, for transferring the charging power of the first battery to the second battery.

In view of the above, the present invention provides a technology for effectively shortening the necessary time to balance the charging powers between the batteries, which can avoid battery damage caused by overcharging.

The drawings as referred to throughout the description of the present invention are for illustrative purpose only, to show the interrelations between the components, but not drawn according to actual scale.

The objectives, technical details, features, and effects of the present invention will be better understood with regard to the detailed description of the embodiments below, with reference to the drawings.

### BRIEF DESCRIPTION OF THE DRAWINGS

FIG. 1 is a schematic block diagram of the battery balance system according to one preferred embodiment of the present invention.

FIG. 2 is a schematic flow chart of the method of battery balance system according to one preferred embodiment of the present invention.

### DESCRIPTION OF THE PREFERRED EMBODIMENTS

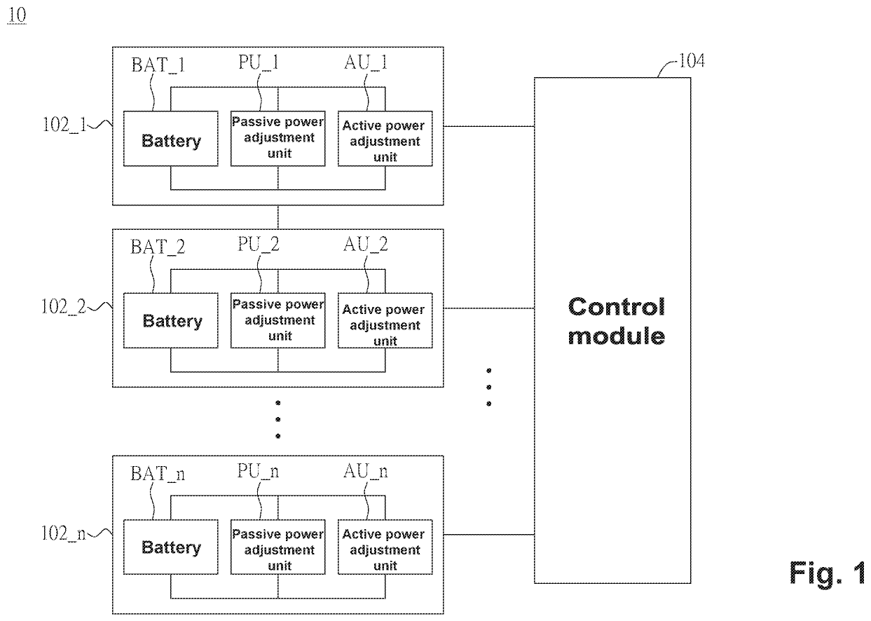

Please refer to FIG. 1, wherein a block diagram of the battery balance system is shown according to one embodiment of the present invention. The battery balance system 10 includes a plurality of battery modules 102_1˜102_n and a control module 104, wherein n is a positive integer, which corresponds to a number of the battery modules.

Each battery module 102_i includes a battery BAT_i, a passive power adjustment unit PU_i, and an AU_i, wherein i=1, 2, . . . , n, are marks respectively corresponding to the battery modules (i.e., i-th battery module). The passive power adjustment unit PU_i and the active power adjustment unit AU_i are coupled to the battery BAT_i.

The control module 104 is coupled to the battery modules 102_1˜102_n. The control module 104 is configured to operably monitor the charging powers of the batteries BAT_1˜BAT_n respectively of the battery modules 102_1˜102_n. For example, the control module 104 monitors the charging power of the battery module 102_i, by a charging power detecting unit (not shown).

In one embodiment, the batteries may include a lead-acid battery, a NiCd battery, a NiWH battery or a lithium battery. Each of the passive power adjustment units PU_1˜PU_n may include at least one resistor, for example. Each of the active power adjustment units AU_1˜AU_n may include a transistor switch, and a magnetic component. When the control module 104 determines the charging power of the battery BAT_i to be too high, an excess charging power of the battery BAT_i can be consumed by the passive power adjustment unit to adjust (or reduce) the charging power of the battery BAT_i. Besides, the control module 104 may also enable the active power adjustment unit AU_i (for example, enable the transistor switch of the active power adjustment unit AU_i), to transfer the excess charging power to other batteries of other battery modules by the magnetic component. In another embodiment, each of the active power adjustment units AU_1˜AU_n may include a transistor switch and an inductor, to transfer the excess charging power to other batteries of other battery modules by the inductor.

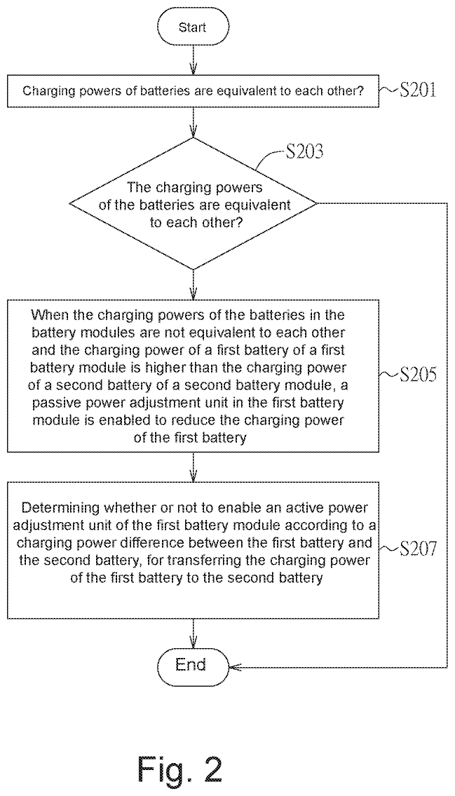

Please refer to FIG. 2, which is a schematic flow chart of the method of battery balance system according to one embodiment of the present invention. The method can be operated in the battery balance system 10 shown in FIG. 1. The method includes steps S201-S207. Substantially, the method of this embodiment is preferably used in a charging period of the battery balance system 10.

In the step S201, the control module 104 monitors the charging powers of the batteries BAT_1˜BAT_n. The control module 104 monitors the charging powers of the battery modules 102_1˜102_n by the charging power detecting units of the battery modules 102_1˜102_n.

In the step 203, the control module 104 determines whether the charging powers of the batteries are equivalent to each other. Substantially, the control module 104 determines the charging powers of the batteries BAT_1˜BAT_n by comparing the charging powers between the batteries BAT_1˜BAT_n. When the charging powers of batteries BAT_1˜BAT_n are equivalent to each other, the control module 104 can determine that there is no need to adjust the charging powers of the batteries BAT_1˜BAT_n and the adjustment step is ended. Or, when the charging powers of the batteries BAT_1˜BAT_n are not equivalent to each other, the control module 104 determines that the charging powers of the batteries BAT_1˜BAT_n need to be adjusted, and the step S205 is performed.

In the step S205, when the charging power of a first battery 102_1 of the batteries BAT_1˜BAT_n of the battery modules 102_1˜102_n is higher than a charging power of a second battery 102_2 of the batteries BAT_1˜BAT_n, a passive power adjustment unit PU_1 of the first battery module 102_1 is enabled, to reduce the charging power of the first battery 102_1 by the passive power adjustment unit PU_1. Importantly, the first and second batteries BAT_1 and BAT_2 in FIG. 1 are for illustrative purpose, but not to limit the battery priority for performing the steps of the present invention. Specifically, the example that the charging power of the first battery BAT_1 is higher than the charging power of the second battery BAT_2, is to describe a situation of “the charging power of any battery is higher than another battery”. When the above situation occurs, the control module 104 will enable the passive power adjustment unit of the battery module including the battery with higher charging power, to reduce the charging power of the battery with the higher charging power.

In the step S207, the control module 104 determines whether or not to enable an active power adjustment unit AU_1 of the first battery module 102_1, according to a charging power difference between the first battery BAT_1 and the second battery BAT_2, for transferring the charging power of the first battery BAT_1 to the second battery BAT_2 by the active power adjustment unit AU_1. Specifically, the control module 104 compares the charging power difference between the first battery BAT_1 and the second battery BAT_2, with a threshold. When the charging power difference between the first battery BAT_1 and the second battery BAT_2 is higher or equal to the threshold, the control module 104 enables the active power adjustment unit AU_1 of the first battery module 102_1. Or when the charging power difference between the first battery BAT_1 and the second battery BAT_2 is less than the threshold, the control module 104 does not enable the active power adjustment unit AU_1 of the first battery module 102_1.

In one embodiment, the charging power difference between the first battery BAT_1 and the second battery BAT_2 can be expressed in a form of percentage, and the threshold may be 10% as an example. When the charging power difference between the first battery BAT_1 and the second battery BAT_2 is less than 10%, the control module 104 enables the passive power adjustment unit PU_1 of the first battery module 102_1, but does not enable the active power adjustment unit AU_1 of the first battery module 102_1. When the charging power difference between the first battery BAT_1 and the second battery BAT_2 is higher than or equal to 10%, the control module 104 enables both of the passive power adjustment unit PU_1 and the active power adjustment unit AU_1 of the first battery module 102_1.

In view of the above, for balancing the charging powers of the batteries, when the control module 104 determines the charging power difference between the first battery BAT_1 and the second battery BAT_2 is less (i.e., the charging power difference is less than the threshold), the control module 104 merely enable the passive power adjustment unit to consume a portion of the charging power to reduce the higher charging power of the higher charged battery. When the control module 104 determines the charging power difference between one battery and another battery is higher (i.e., the charging power difference is higher or equal to the threshold), the control module 104 enables not only the passive power adjustment unit to consume a portion of the higher charging power of the battery, but also the active power adjustment unit, to transfer at least a portion of the higher charging power to the battery with less charging power, for rapidly balancing the charging powers of all of the batteries.

Besides, in order to avoid damage of the batteries BAT_1˜BAT_n due to overcharging, the control module 104 can force off a charging path wherein at least one battery is 100% charged. In a period of forcing off the charging path, the battery balance system 10 can be still workable to balance the charging powers of all of the batteries. After reducing an electrical storage or the charging power of the 100% charged battery by the aforementioned method, the control module 104 may turn on the charging path again.

In the present invention, based on the coordination of the passive power adjustment unit and the active power adjustment unit, the charging powers of all of the batteries can be balanced by the passive power adjustment unit when the charging power difference is less. When the battery power difference is higher, the passive power adjustment unit and active transfer can be both used to balance the charging powers of the batteries, with the power consumption and the active power transfer. It can effectively shorten the time required for achieving the charging power balance of the batteries, and prevent the battery from being damaged due to overcharging.

In one embodiment, the battery balance system 10 provided by the present invention, can be preferably used for LED lighting facility, wherein the batteries BAT_1˜BAT_n are respectively coupled to different LED lighting sources LED_1˜LED_n (not shown). By adjusting and balancing the charging powers of all of the batteries, brightness and lighting intensity of all of the LED can be adjusted and balanced, such that the lifetime of the LED lighting facility can be well maintained to be extended.

The present invention has been described in considerable detail with reference to certain preferred embodiments thereof. It should be understood that the description is for illustrative purpose, not for limiting the scope of the present invention. Those skilled in this art can readily conceive variations and modifications within the spirit of the present invention. Besides, an embodiment or a claim of the present invention does not need to attain or include all the objectives, advantages or features described in the above. The abstract and the title are provided for assisting searches and not to be read as limitations to the scope of the present invention.

What is claimed is:

1. A battery balance system, comprising:
a plurality of battery modules, each of which comprises a battery, a passive power adjustment unit and an active power adjustment unit, wherein the battery is coupled to the passive power adjustment unit and the active power adjustment unit; and
a control module, coupled to the battery modules, for monitoring a plurality of charging powers of the batteries;
wherein, in a charging period, when a charging power of a first battery in a first battery module of the battery modules is higher than a charging power of a second battery in a second battery module of the battery modules, the control module enables the passive power adjustment unit of the first battery module, to reduce the charging power of the first battery by the passive power adjustment unit of the first battery module, and the control module decides whether or not to enable the active power adjustment unit of the first battery module according to a charging power difference between the first battery and the second battery, for transferring the charging power of the first battery to the second battery by the active power adjustment unit of the first battery module.

2. The battery balance system of claim 1, wherein when the charging power difference between the first battery and the second battery is higher or equal to a threshold, the control module enables the active power adjustment unit of the first battery module; or when the charging power difference between the first battery and the second battery is less than the threshold, the control module does not enable the active power adjustment unit of the first battery module.

3. The battery balance system of claim 1, wherein the batteries comprise a lead-acid battery, a NiCd battery, a NiWH battery or a lithium battery.

4. The battery balance system of claim 1, wherein the passive power adjustment unit comprises at least one resistor.

5. The battery balance system of claim 1, wherein the active power adjustment unit comprises at least one of a transistor switch, an inductor and a magnetic component.

6. An operation method of battery balance system, comprising:
monitoring a plurality of charging powers of a plurality of battery modules;
determining whether the charging powers of the batteries are equivalent to each other;
when the charging powers of the batteries in the battery modules are not equivalent to each other, and the charging power of a first battery of a first battery modules of the battery modules is higher than a charging power of a second battery of a second battery modules of the battery modules, a passive power adjustment unit in the first battery module is enabled to reduce the charging power of the first battery by the passive power adjustment unit; and
determining whether or not to enable an active power adjustment unit of the first battery module according to a charging power difference between the first battery and the second battery, for transferring the charging power of the first battery to the second battery by the active power adjustment unit.

7. The operation method of battery balance system of claim 6, wherein when the charging power difference between the first battery and the second battery is higher or equal to a threshold, enabling the active power adjustment unit of the first battery module; or when the charging power difference between the first battery and the second battery is less than the threshold, not enabling the active power adjustment unit of the first battery module.

8. The operation method of battery balance system of claim 6, wherein the battery comprises a lead-acid battery, a NiCd battery, a NiWH battery or a lithium battery.

9. The operation method of battery balance system of claim 6, wherein the passive power adjustment unit comprises at least one resistor.

10. The operation method of battery balance system of claim 6, wherein the active power adjustment unit comprises at least one of a transistor switch, an inductor and a magnetic component.
